(19) United States
(12) Patent Application Publication
(10) Pub. No.: US 2016/0106034 A1
(43) Pub. Date: Apr. 21, 2016

(54) GRASS-CUTTING HEAD WITH CUTTING LINE WITH CUTTING LINE REFILLING WITHOUT OPENING

(71) Applicant: ARNETOLI MOTOR S.R.L., Reggello (IT)

(72) Inventor: Fabrizio ARNETOLI, Reggello (IT)

(21) Appl. No.: 14/568,676

(22) Filed: Dec. 12, 2014

(30) Foreign Application Priority Data
Oct. 16, 2014 (IT) FI2014A000235

(51) Int. Cl. A01D 34/416

(52) U.S. Cl. CPC A01D 34/4166

(57) ABSTRACT

The grass-cutting head (1) with cutting line (F) includes an outer housing (3) and a spool (5) housed in the outer housing. The spool includes an axial cavity (9) and two opposite channels (17) for insertion of the cutting line (F). A spring (11), elastically biases the spool with respect to the housing, and two bushings (7) are approximately diametrically opposite in a lateral wall of the outer housing (3), which are alignable with openings of the two opposite cutting line insertion channels. In the axial cavity (9) of the spool (5) there are formed two opposite projections (21) for supporting the spring (11), forming pairs of lead-in and guide surfaces (21A) converging toward respective openings (17B) of the two opposite cutting line insertion channels, facing the axial cavity (9) of the spool (5).

### FIELD OF THE INVENTION

Embodiments described herein relate to grass-cutting heads and more in particular to grass-cutting heads having a cutting line, wherein a cutting line is wound around a spool housed in an outer housing, provided with bushings for the passage of the line.

### STATE OF THE ART

In the field the gardening equipment, both for professional and amateur use, grass-cutting heads are known, which use a line made of plastic material, typically nylon or the like, as cutting element. These heads are equipped with a spool around which a supply of cutting line is wound. The spool is housed in a casing or housing, provided with openings for the passage of the cutting line toward the outside. Ends of the cutting line that project toward the outside of the housing are used as cutting members, spinning the head at high speed about the rotation axis thereof. The ends of the cutting line projecting from the housing are pulled taut by centrifugal force and act as blades on the vegetation to be cut.

During use the cutting line is worn out or breaks and, through appropriate devices provided on the cutting head, new line is unwound from the spool and made to project from the body of the head.

During use the head is fixed to the end of a motor shaft of a mower provided with an electric motor or an internal combustion engine. Mechanical coupling between head and motor shaft is obtained by means of a mechanical coupling insert. This mechanical coupling insert can be of greater or lesser length, depending on the type of head or of the type of motor shaft used. In certain cases, it can extend coaxially to the spool inside an axial cavity of the spool.

Usually, to load the line around the spool, i.e. to wind a certain amount of line around the spool and form a supply of line that can be gradually unwound during use of the head, when the cutting line is used up or breaks, opening the head is required to extract the spool and attach the cutting line or lines thereto. The line or lines are then wound around the central body of the spool, leaving the ends of the line free. These are passed from the inside through the bushings for the passage of the cutting line, provided on the wall of the casing of the head and, finally, the casing of the head, with the spool inside and the line wound about the spool, is closed.

These operations are particularly complex, laborious and time-consuming. Consequently, systems have been designed that allow the line to be loaded into the head, by winding it around the spool, without the need to open the head. An example of a head of this type, which can be loaded with new line without opening the casing inside which the spool is housed, is described in EP0525195. For this purpose, the body of the spool comprises a cutting line passage. The cutting line passage is aligned with the openings or bushings provided in the wall of the housing of the spool. The cutting line is inserted through one of the bushings, into and through the passage and then made to exit from a second bushing, opposite the first one. Once the line has been inserted and passed through the head, the spool is rotated with respect to the casing containing it, so that the line is wound around the spool and forms a supply of line. As the mechanical coupling insert for coupling the head to the motor shaft extends at the center of the spool, to allow insertion of the line through the passage provided in the body of the spool it is necessary for the passage to be curved and/or offset with respect to the axis of the spool. This makes insertion of the line difficult.

Variants of this general concept are described in U.S. Pat. No. 5,765,287. In this case the line is made to pass through the body of the spool in a position such as not to interfere with the mechanical coupling insert for coupling to the motor shaft. This head is not suitable to be used with inserts of greater axial length, as they would obstruct the passage of the line.

U.S. Pat. No. 8,025,249 describes a grass-cutting head with cutting line, wherein, in order to allow the passage of the line also when an mechanical coupling insert for coupling to the motor shaft passes through the central body of the spool, a curved channel extending between two opposite points of a flange of the spool is provided, forming between the two ends thereof a curve that extends around the central cavity of the spool, without interfering therewith. The curved channel thus formed allows the cutting line to be inserted from one side to the other of the spool, making it curve around the central cavity of the spool, into which the insert for coupling the head to the motor shaft can be inserted.

US2011/0302793 discloses a grass-cutting head with a spool for line winding, wherein in the spool flange guide channels for the line are formed, which have two diametrically opposite rectilinear portions, connected to one another by a double intermediate curved channel. The two branches of the double intermediate channel extend around an axial cavity of the spool.

This solution is complex and costly. Moreover, insertion of the line through the curved channel is made difficult by the high friction generated between the line and the walls of the channel.

U.S. Pat. No. 8,567,074 describes a grass-cutting head with a spool and a housing provided with bushings for the passage of the line. The head has a line dispensing mechanism, comprising a spring that elastically biases the spool with respect to the housing. The spool comprises two diametrically opposite channels that lead into an axial cavity and can be axially aligned with bushings provided in the lateral wall of the casing. Insertion and winding of cutting line around the spool is obtained by aligning the bushings with the channels and inserting the line diametrically through the winding head. Snap coupling systems facilitate correct mutual angular positioning between spool and head, such that the channels are aligned with the bushings. In this embodiment the line insertion channels terminate directly on a cylindrical wall that defines the axial cavity of the spool, into which a mechanical coupling insert for mechanically coupling the grass-cutting head to the mower can be inserted. A circular abutment, which can be defined by a washer, forms a supporting surface for the spring, so that the latter does not interfere with the diametrical passage of the line, when the latter is made to pass from one insertion channel to the other, passing through the cavity of the spool.

Therefore, there is the need to provide a grass-cutting head that allows simpler and more efficient refilling of the cutting line without opening the casing of the head and without the need to extract the spool from the casing.

### SUMMARY OF THE INVENTION

According to embodiments disclosed herein, a grass-cutting head with cutting line is provided, comprising an outer housing and a spool housed in the outer housing. The spool comprises a central body with a rotation axis, around which a cutting line is wound, an axial cavity in the central body, into which an insert for mechanical coupling of the head to a motor shaft can be inserted, and two opposite cutting line insertion channels, each of which extends approximately radially from a respective first opening toward a respective second opening positioned in the axial cavity. The head also comprises a coil spring arranged inside the housing and substantially coaxial to the spool, which elastically biases the spool with respect to the housing. The spool can have opposite series of teeth cooperating with opposite abutments so that a reciprocating movement in axial direction while the head is rotating can cause, in a known manner, dispensing of the cutting line as a result of a stepped rotation of the spool with respect to the housing. Moreover, the housing comprises at least two bushings in approximately diametrically opposite positions in a lateral wall. The bushings can be aligned with the cutting line insertion channels.

Two opposite spring supporting projections are arranged in the axial cavity of the spool. The two projections form pairs of lead-in and guide surfaces converging toward opposed openings of the two opposite cutting line insertion channels, which openings are facing the inside of the axial cavity of the spool.

In this way, the cutting line that exits from one of the two insertion channels and enters the axial cavity is guided by the guide surfaces formed by the projections toward the opposite insertion channel, facilitating insertion and passage of the cutting line.

In practice, with the projections for supporting the spring that form the converging guide walls of the line toward the diametrically internal openings of the guide channels, more effective guiding of the cutting line during insertion thereof is obtained, with respect to systems in which there is only the empty space of the axial cavity of the spool between one channel and the other, for example as illustrated in embodiments described in U.S. Pat. No. 8,567,074.

In practice, each line insertion channel has a diametrically external opening and a diametrically internal opening. This latter faces the axial cavity of the spool. The two internal openings are opposite each other. The two spring supporting projections form (with walls that can be substantially parallel to the axis of the spool and substantially orthogonal to spring supporting surfaces), in front of each of the two opposed diametrically internal openings, two guide surfaces converging toward the respective opening.

The spring supporting projections can be formed on a member separate from the spool and attachable thereto. In other embodiments the spool monolitically forms also the spring supporting projections.

The structure of the spool is simplified and its size reduced with respect to configurations wherein the spool has a continuous channel that extends from a first inlet opening to a second outlet opening, aligned diametrically and positioned on the outer edge of a flange, and between which a continuous channel extends, which forms a curve around the axial cavity, to ensure that the line does not enter the axial cavity of the spool.

To obtain an even better guiding effect, under each of the diametrically internal openings of the two opposite line insertion channels a wall can be provided, which is transverse with respect to the rotation axis of the spool, and extends from one to the other of the two lead-in surfaces, formed by the two spring supporting projections, converging toward the respective opening. These walls form two respective surfaces substantially transverse with respect to the rotation axis of the spool, from which the respective converging lead-in surfaces formed by the the spring supporting projections extend.

Features and embodiments are disclosed here below and are further set forth in the appended claims, which form an integral part of the present description. The above brief description sets forth features of the various embodiments of the present invention in order that the detailed description that follows may be better understood and in order that the present contributions to the art may be better appreciated. There are, of course, other features of the invention that will be described hereinafter and which will be set forth in the appended claims. In this respect, before explaining several embodiments of the invention in details, it is understood that the various embodiments of the invention are not limited in their application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may readily be utilized as a basis for designing other structures, methods, and/or systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The invention will be better understood by following the description and accompanying drawing, which shows practical non-limiting embodiments of the invention. More in particular, in the drawing:

FIGS. 1 and 2 show longitudinal sections of a grass-cutting head in a first embodiment and with the spool in two different axial positions inside the casing;

FIG. 3 shows a sectional axonometric view of the grass-cutting head of FIGS. 1 and 2;

FIG. 4 shows a plan view of the spool of the head of FIGS. 1 to 3;

FIGS. 5 and 6 show sections along V-V and VI-VI of FIG. 4;

FIG. 7 shows a sectional axonometric view of the spool of FIGS. 4 to 6;

FIG. 8 shows an axonometric view of the spool of FIGS. 4 to 7, with the supporting member separated from the spool;

FIGS. 9 and 10 show sections analogous to the sections of FIGS. 1 and 2, of a grass-cutting head with a different mechanical coupling insert;

FIGS. 11 and 12 show longitudinal sections of a grass-cutting head in a further embodiment, with the spool in two different axial positions inside the housing;

FIG. 13 shows a sectional axonometric view of the grass-cutting head of FIGS. 11 and 12;

FIG. 14 shows a plan view of the grass-cutting head of FIGS. 11, 12 and 13;

FIGS. 15 and 16 show sections along the lines XV-XV and XVI-XVI of FIG. 14;

FIG. 17 shows a sectional axonometric view of the spool of FIGS. 14 to 16;

FIGS. 18 and 19 show longitudinal sections of the head of FIGS. 11 and 12 with a different mechanical coupling insert;

FIG. 20 shows an exploded view, analogous to the view of FIG. 8, in a further embodiment.

### DETAILED DESCRIPTION OF EMBODIMENTS

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

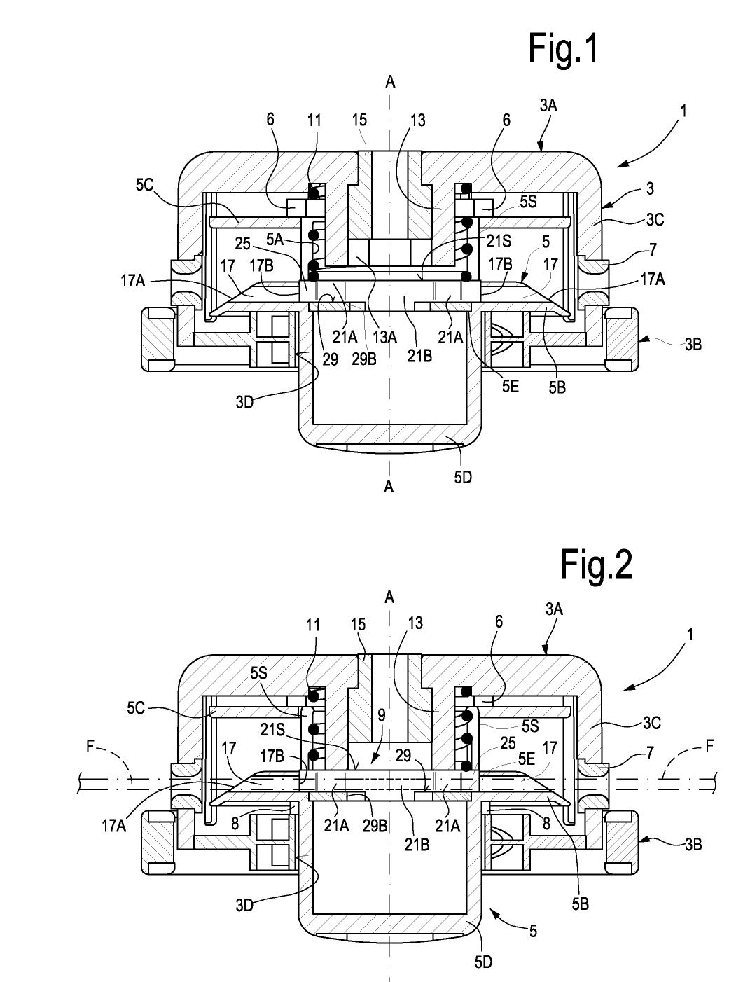

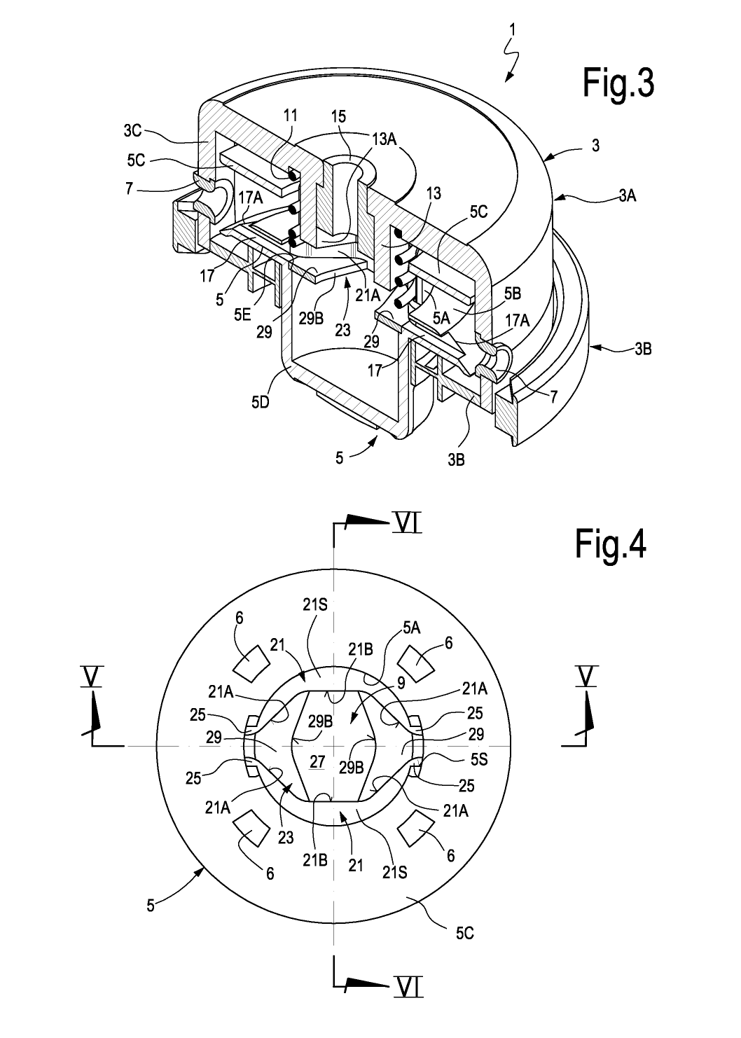

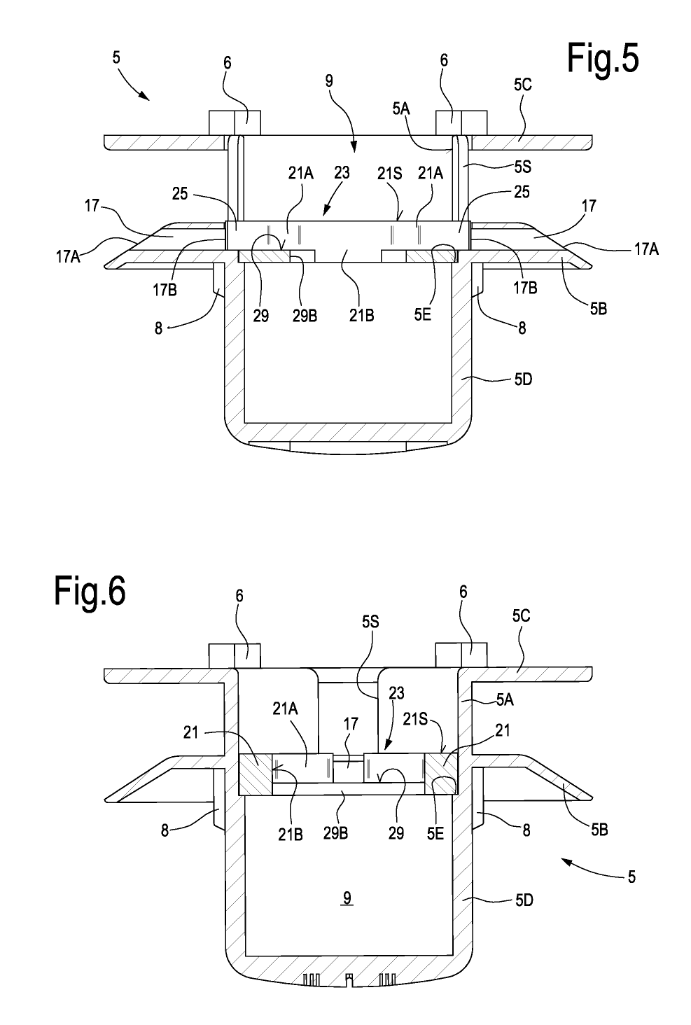

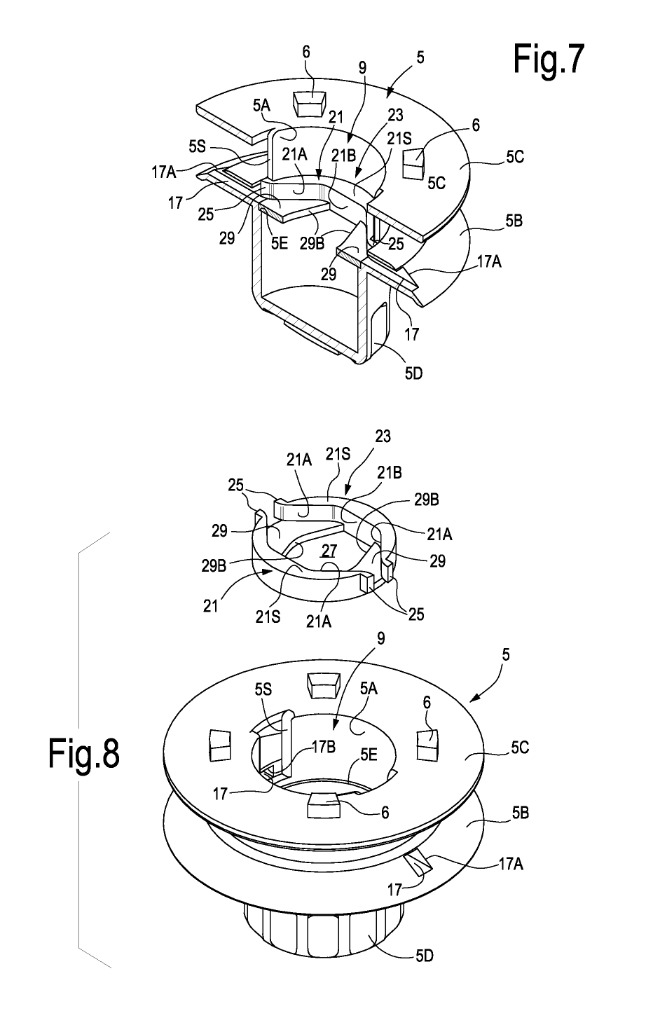

With initial reference to FIGS. 1 to 8, in a possible embodiment a grass-cutting head 1 is provided, comprising an outer housing 3, wherein a spool 5 is arranged. The housing 3 can comprise a first portion 3A, or body, and a second portion 3B, or cover, reversible coupled to each other. Coupling can be obtained by means of elastic tabs, not visible. Embodiments of the mutual coupling means between the two portions 3A, 3B of the housing are described, for example, in U.S. Pat. No. 8,615,887, the entire contents of which are hereby incorporated by reference.

The first portion 3A of the housing 3 can comprise a lateral wall 3C, for example approximately cylindrical. In the lateral wall 3C at least two bushings 7 can be inserted, each provided with a through hole for the passage of a cutting line F. The bushings 7 are arranged in approximately diametrically opposite positions.

The spool 5 can comprise a central body 5A with a rotation axis A-A, coincident with the rotation axis of the grass-cutting head when the spool 5 is inserted therein. The spool 5 can also comprise a first flange 5B. In some embodiments the spool can comprise a second flange 5C axially spaced with respect to the first flange 5B. Between the first flange 5B and the second flange 5C a space is formed, where the cutting line F can be wound.

The spool 5 can also comprise a knob 5D that extends from the flange 5B toward the outside of the housing 3 of the head 1 through a hole 3D formed in the second portion 3B of the housing 3.

The spool 5 is provided with an axial cavity 9 formed in the central body 5A. In the axial cavity 9 a spring 11 is partly housed, which elastically biases the spool 5 with respect to the housing 3, pushing the spool 5 toward and against the second portion 3B of the housing 3.

The spring 11 can be held in position in the housing 3 by means of a collar 13 that can be formed on the first portion 3A of the housing 3 and projects toward the inside of the housing, coaxially to the spool 5. The spring 11 can be arranged around the collar 13.

The spool 5 can be provided with a first series of teeth 6, for example provided on the second flange 5C, and with a second series of teeth 8, for example provided on the first flange 5B. The teeth 6 and 7 are offset with respect to each other and cooperate with respective abutments provided on the front walls of the housing 3, in a known manner. By moving the spool 5 axially against the force of the spring 11 it is possible to temporarily release the teeth 8 from the respective abutments and rotate the spool by one step, the step corresponding to the offset between the teeth 6 and 8, i.e. between the respective abutments. The axial movement of the spool 5 inside the housing 3 obtained by compression of the spring 11 can be controlled by acting on the knob 5D with which the spool 5 is equipped and which is accessible from the outside. This knob is also used manually to rotate the spool 5 inside the housing 3.

The two axial positions taken by the spool 5 in the housing 3 are shown in FIGS. 1 and 2.

This mechanism for dispensing the line is already known and does not require further description.

The first portion 3A of the housing 3 can comprise an upper through hole for an insert 15 for mechanical coupling of the grass-cutting head 1 to a motor shaft of a mower (not shown), to which the grass-cutting head 1 can be fitted. The mechanical coupling insert 15 can be made of metal and can have a threaded hole, wherein one end of the threaded motor shaft, not shown, can be engaged. The mechanical coupling insert 15 can have an at least partly non-circular cross section, for example hexagonal, to provide torsional coupling between the mechanical coupling insert 15 and the housing 3 of the head. In this way, the rotation torque supplied by the motor shaft to the mechanical coupling insert 15 is transmitted to the grass-cutting head 1. The mechanical coupling insert 15 can be housed inside the collar 13 that forms for this purpose an axial seat 13A, with a cross section corresponding to the cross section of the mechanical coupling insert 15, so as to obtain a mechanical connection through positive fit between insert 15 and grass-cutting head 1.

The spool 5 comprises two opposite channels 17 for insertion of the cutting line F (FIG. 2). The two opposite cutting line insertion channels 17 can be formed in the first flange 5B of the spool 5. Each of the two opposite cutting line insertion channels 17 can comprise a first opening 17A and a second opening 17B. The openings 17A are diametrically external and the openings 17B are diametrically internal and opposite each other. Each cutting line insertion channel 17 extends radially from the first opening 17A to the second opening 17B and can have a substantially rectilinear shape.

The first opening 17A of each cutting line insertion channel 17 can be formed along the perimeter edge of the first flange 5B. The second opening 17B of each cutting line insertion channel 17 can be formed on the internal wall of the axial cavity 9 of the central body 5A of the spool 5.

The arrangement of the cutting line insertion channels 17 and of the bushings 7 is such that the cutting line insertion channels 17 can be axially aligned with the bushings 7, as shown in FIG. 2. In this arrangement, the cutting line F can be inserted from the outside through the grass-cutting head 1, without the need to open the head. Alignment between bushings 7 and channels 17 can be facilitated through a configuration as described in U.S. Pat. No. 8,567,074, the content of which is incorporated in the present disclosure.

A supply of cutting line F can be wound around the central body 5A of the spool 5 once the cutting line F has been introduced through the bushings 7 and the cutting line insertion channels 17, making a certain length of cutting line F project from both bushings 7. At this point, winding of the line can be obtained simply by rotating the spool 5 in a winding direction about the axis A-A with respect to the housing 3, in a known manner. The portions of cutting line F that project from the heads 7 are gradually withdrawn inside the housing 3 until only two portions of cutting line of limited length, which are used to cut the vegetation, project from the cutting head 1.

During the step of insertion of the cutting line F through the grass-cutting head 1, the cutting line F is inserted from one of the bushings 7 and enters one of the cutting line insertion channels 17 through the respective first opening 17A. The cutting line must then exit from the second opening 17A of the channel 17, through the axial cavity 9 and enter through the second opening 17B in the opposite cutting line inserction channel 17, pass through this latter and, exiting from its first opening 17A, enter the bushing 7 and exit therefrom. To facilitate passage of the cutting line F through the central body 5A of the spool 5, passing diametrically through the axial cavity 9, without the line jamming while passing from one of the openings 17B of one channel 17 to the opening 17B of the opposite channel, also preventing the cutting line from interfering with the spring 11, two opposite projections 21 are formed in the axial cavity 9. The projections 21 form surfaces 21S for supporting the spring 11. These surfaces 21S for supporting the spring 11 are substantially orthogonal to the rotation axis A-A of the spool.

The projections 21 can be substantially symmetrical with respect to a plane containing the axis A-A of the spool and passing through the cutting line insertion channels 17.

In the embodiment illustrated in FIGS. 1 to 10 the projections 21 are formed by a supporting member 23 for supporting the spring 11. The supporting member 23 can be formed by an element separate with respect to the spool and can be inserted inside the cavity 9 of the spool 5. In some embodiments, inside the cavity 9 of the spool 5 a shoulder 5E can be provided, which forms a mounting seat for the supporting member 23.

The supporting member 23 can have diametrically opposite appendages 25 that interface with the cutting line insertion channels 17. In particular, the supporting member 23 can comprise two pairs of diametrically opposite appendages, each pair being arranged in front of one of the two second openings 17B of the cutting line insertion channels 17, so as to form a sort of prolongation of the channels toward the axial cavity 9 of the spool. The pairs of diametrically opposite appendages 25 can be inserted into longitudinal grooves 5S formed in the central body 5A of the spool 5, so as to guide the supporting member 23 when it is inserted in the axial cavity 9 of the spool until it abuts against the shoulder 5E.

Advantageously each of said projections 21 has a wall oriented toward the axial cavity 9 and delimiting said cavity. Each of the two walls defines respective surfaces 21A converging toward the openings 17B of the cutting line insertion channels 17. In practice, in front of the second opening 17B of each cutting line insertion channel 17 two surfaces 21A extend, which substantially symmetrically converge toward the opening, and diverge from one another starting from the opening 17B, toward respective intermediate surfaces 21B of the wall of the respective projection 21. The intermediate surfaces 21 B can be substantially parallel to the plane of symmetry of the projections 21. The surfaces 21A and 21B can be substantially orthogonal to the surfaces 21S on which the spring 11 rests.

When a cutting line F is inserted through the grass-cutting head 1, the end of the cutting line F is inserted into a bushing 7 and guided through one of the two opposite cutting line insertion channels 17 until reaching the second opening 17B of said cutting line insertion channel 17. The end of the cutting line, which in this way faces the inside of the axial cavity 9 of the spool, is guided sequentially on the surfaces 21A, 21B, 21A of one of the two projections 21 until entering the opposed second opening 17B of the opposite cutting line insertion channel.

The cutting line F is normally made of plastic material and packaged in reels of considerable length, from which the required quantity of cutting line F is cut. When the cutting line F is inserted through the grass-cutting head 1, it retains a curvature due to the fact that it has been stored for a long time wound in the reel. The surfaces 21A, 21B allow the curved cutting line to be guided correctly, making it pass diametrically through the axial cavity 9 of the spool 5.

The supporting member 23 can be substantially disk-shaped, as can be seen in particular in FIG. 8 where it is shown separated from the spool 5. The supporting member 23 can have a central aperture 27. This central aperture 27 is partly delimited by the surfaces 21B and for the remaining part by edges 29B of walls 29 extending between the surfaces 21A of the two opposite projections 21 and positioned at a lower height with respect to the appendages 25, all as clearly shown in the top part of FIG. 8. Each of said walls 29 defines a surface from which the converging line lead-in surfaces 21A extend toward the respective opening 17B. In this way, an optimal guide of the cutting line is obtained when it is inserted through a channel 17. The head of the line that enters the axial cavity 9 from one of the channels 17 is directed toward the second opening 17B, or diametrically internal opening 17B, of the opposite channel 17 and it enters easily due to the guiding action of the converging walls 21A, and of the wall or surface 29 below.

As can be seen in FIG. 4 and in FIG. 8, the aperture 27 can have an elongated shape with a major axis and a minor axis. In FIG. 4 the major axis coincides with the line of the section plane VI-VI, while the minor axis coincides with the line of the section plane V-V. The minor dimension of the aperture is therefore the one coinciding with the direction along which the cutting line insertion channels 17 are aligned. The major direction is substantially orthogonal to the surfaces 21B.

In the embodiment described above the insert 15 has a small axial length and is housed fully in the seat 13A formed by the collar 13. Therefore, the axial cavity 9 of the spool is completely free and the line F can easily pass therethrough in radial direction, guided by the walls 21A, 21B of the projections 21. These latter ensure that the spring 11 is retained in a position above the openings 17B of the cutting line insertion channels 17, preventing interference between the cutting line F and the spring 11.

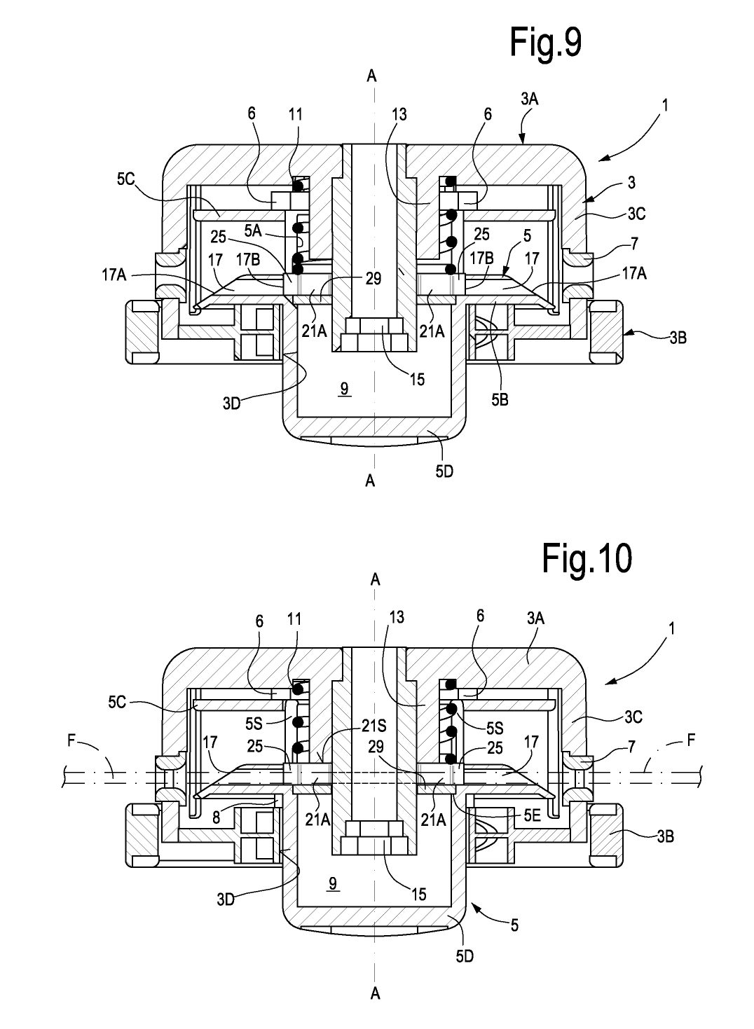

FIGS. 9 and 10 show, in sections similar to those of FIGS. 1 and 2, a grass-cutting head 1 substantially the same as the one described with reference to FIGS. 1 to 8, with the difference that the insert 15 for mechanical coupling of the grass-cutting head 1 to the motor shaft of a mower has a greater axial length and extends from the collar 13 in the axial cavity 9 of the spool 5 to beyond the supporting member 23 and the respective projections 21. The aperture 27 formed by the supporting member 23 allows the passage of the insert 15. In this case, when the cutting line F is inserted through the head, it again enters the cavity 9 of the spool 5 and passes around the insert 15, guided by the surfaces 21A, 21B, 21A partly forming the wall of the axial cavity 9.

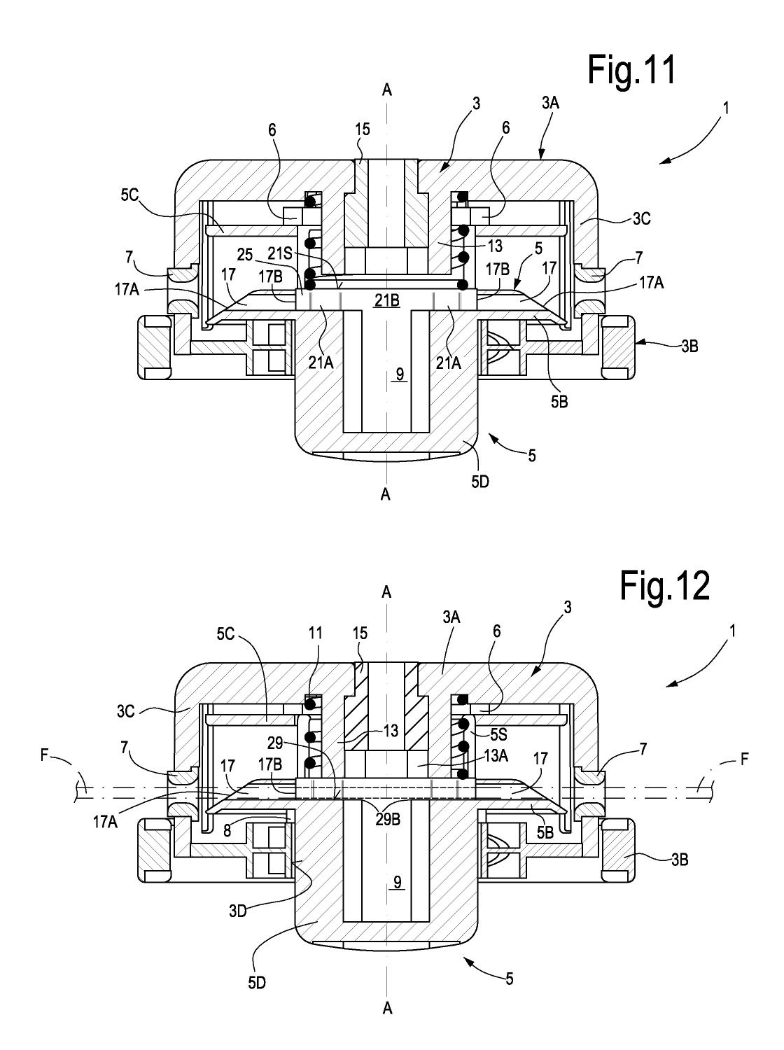

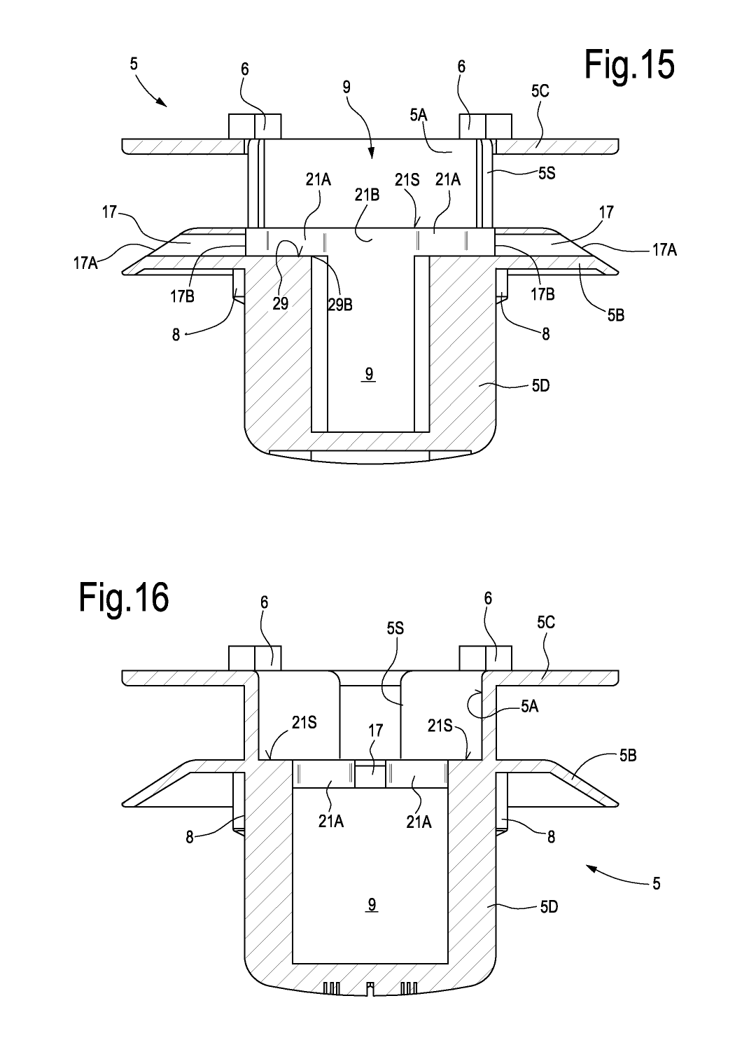

FIGS. 11 to 17 show a different embodiment of a grass-cutting head. The same numbers indicate the same or equivalent parts to those described with reference to FIGS. 1 to 8. The substantial difference between the embodiment of FIGS. 1 to 10 and the embodiment of FIGS. 11 to 17 consists in the fact that in the second group of figures the spring supporting projections are integrally formed as one piece by the spool, rather than by a separate member, as in the previously described embodiment.

With initial reference to FIGS. 11 to 19, in this second embodiment a grass-cutting head 1 is provided, comprising an outer housing 3, wherein a spool 5 arranged. The housing 3 can comprise a first portion 3A, or body, and a second portion 3B, or cover, reversibly coupled to each other. Coupling can be obtained by means of elastic tabs, not visible.

The first portion 3A of the housing 3 can comprise a lateral wall 3C, for example approximately cylindrical. In the lateral wall 3C at least two bushings 7 can be inserted, each provided with a through hole for the passage of a cutting line F. The bushings 7 are arranged in approximately diametrically opposite positions.

The spool 5 can comprise a central body 5A with a rotation axis A-A coincident with the rotation axis of the grass-cutting head when the spool 5 is inserted therein. The spool 5 can also comprise a first flange 5B. In some embodiments the spool can comprise a second flange 5C axially spaced with respect to the first flange 5B. Between the first flange 5B and the second flange 5C a space is formed, wherein the cutting line F can be wound.

The spool 5 can also comprise a knob 5D that extends from the flange 5B toward the outside of the housing 3 of the head 1 through a hole 3D formed in the second portion 3B of the housing 3.

The spool 5 is provided with an axial cavity 9 formed in the central body 5A. In the axial cavity 9 a spring 11 is partly housed, which elastically biases the spool 5 with respect to the housing 3, pushing the spool 5 toward and against the second portion 3B of the housing 3.

The spring 11 can be retained in position in the housing 3 through a collar 13 that can be formed on the first portion 3A of the housing 3 and projects toward the inside of the housing coaxial to the spool 5. The spring 11 can be arranged around the collar 13.

The spool 5 can be provided with a first series of teeth 6, for example provided on the second flange 5C, and with a second series of teeth 8, for example provided on the first flange 5B. The teeth 6 and 7 are offset with respect to each other and cooperate with respective abutments provided on the front walls of the housing 3, in a known manner. By moving the spool 5 axially against the force of the spring 11 it is possible to temporarily release the teeth 8 from the respective abutments and rotate the spool by one step, the step corresponding to the offset between the teeth 6 and 8, i.e. between the respective abutments. The axial movement of the spool 5 inside the housing 3 obtained through compression of the spring 11 can be controlled by acting on the knob 5D with which the spool 5 is equipped and accessible from the outside. This knob is also used manually rotate the spool 5 inside the housing 3.

The two axial positions adopted by the spool 5 in the housing 3 are shown in FIGS. 11 and 12.

The first portion 3A of the housing 3 can comprise an upper through hole for an insert 15 for mechanical coupling of the grass-cutting head 1 to a motor shaft of a mower (not shown), to which the grass-cutting head 1 can be fitted. The mechanical coupling insert 15 can be housed inside the collar 13 that forms for this purpose an axial seat 13A having a cross section corresponding to the cross section of the mechanical coupling insert 15, so as to obtain a mechanical connection through positive fit between insert 15 and grass-cutting head 1.

The spool 5 comprises two opposite channels 17 for insertion of the cutting line F (FIG. 12). The two opposite cutting line insertion channels 17 can be formed in the first flange 5B of the spool 5. Each of the two opposite cutting line insertion channels 17 can comprise a first opening 17A, or diametrically external opening, and a second opening 17B, or diametrically internal opening. Each cutting line insertion channel 17 extends radially from the first opening 17A to the second opening 17B and can have a substantially rectilinear shape.

The first opening 17A of each cutting line insertion channel 17 can be formed along the perimeter edge of the first flange 5B. The second opening 17B of each cutting line insertion channel 17 can be formed on the inner wall of the axial cavity 9 of the central body 5A of the spool 5.

The arrangement of the cutting line insertion channels 17 and of the bushings 7 is such that the cutting line insertion channels 17 can be axially aligned with the bushings 7, as shown in FIG. 12. In this arrangement, the cutting line F can be inserted from the outside through the grass-cutting head 1, without the need to open the head. A supply of cutting line F can be wound around the central body 5A of the spool 5 in the manner described above with reference to FIGS. 1 to 8.

To facilitate passage of the cutting line F through the central body 5A of the spool 5, passing diametrically through the axial cavity 9, two opposite projections 21 are formed in the axial cavity. The projections 21 form surfaces 21S for supporting the spring 11. These surfaces 21S for supporting the spring 11 are substantially orthogonal to the rotation axis A-A of the spool.

The projections 21 can be substantially symmetrical with respect to a plane containing the axis A-A of the spool and passing through the cutting line insertion channels 17.

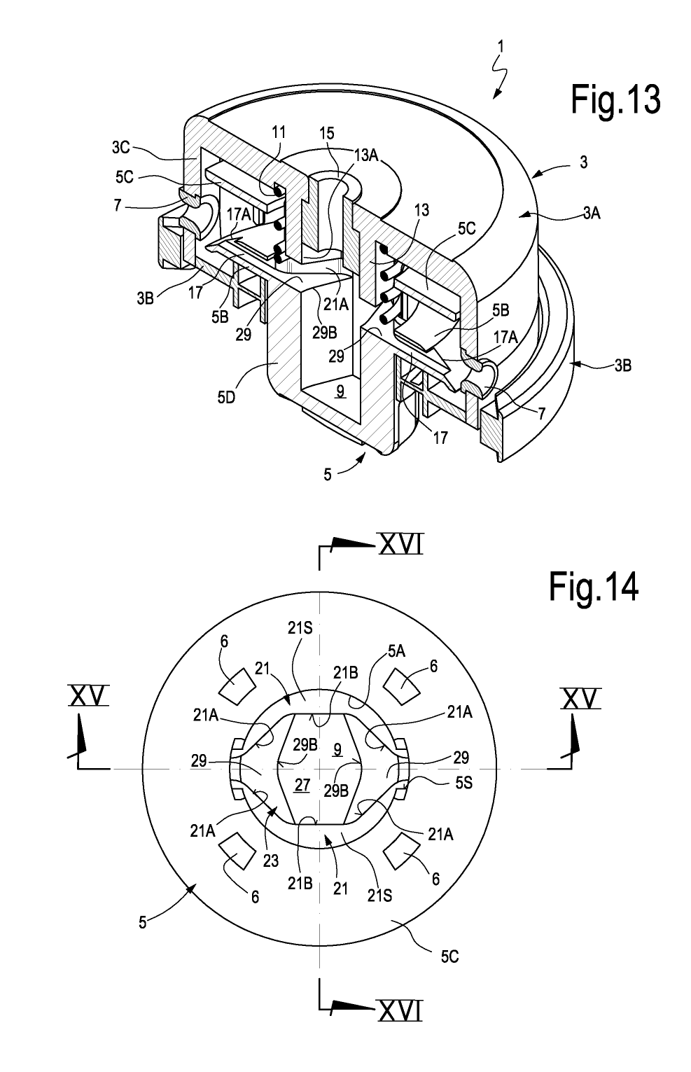

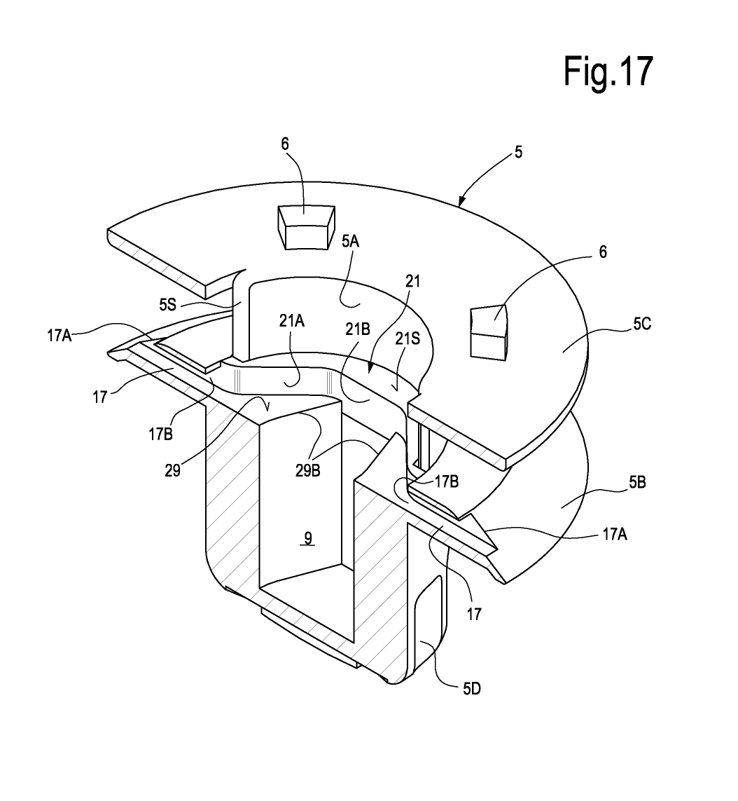

In the embodiment illustrated in FIGS. 10 to 17, the projections 21 are formed in one piece with the body of the spool, as can be seen in particular in FIGS. 13 and 17.

Advantageously each of the projections 21 has a wall oriented toward the axial cavity 9 and delimiting this cavity. Each of the two walls defines respective surfaces 21A converging toward the openings 17B of the cutting line insertion channels 17 for. In practice, in front of the second opening 17B of each cutting line insertion channel 17 two surfaces 21A extend, which converge toward the opening, substantially symmetrical and which diverge from one another starting from the opening 17B, toward respective intermediate surfaces 21B of the wall of the respective projection 21. The intermediate surfaces 21B can be substantially parallel to the plane of symmetry of the projections 21, corresponding to the section plane along the line XV-XV in FIG. 14. The surfaces 21A and 21B can be substantially orthogonal to the surfaces 21S on which the spring 11 rests.

When a cutting line F is inserted through the grass-cutting head 1, the end of the cutting line F is inserted into a bushing 7 and guided through one of the two opposite cutting line insertion channels 17 until reaching the second opening 17B of said cutting line insertion channel 17. The end of the cutting line that in this way faces the inside of the axial cavity 9 of the spool is guided sequentially on the surfaces 21A, 21B, 21A of one of the two projections 21 until entering the opposed second opening 17B of the opposite cutting line insertion channel.

In the cavity 9 of the body 5A of the spool 5, in addition to the projections 21 with the respective surfaces 21S, 21A, 21B, there are also formed two substantially flat walls or surfaces 29, which are approximately orthogonal to the rotation axis A-A of the spool. The surfaces 29 are located under the openings 17B of the cutting line insertion channels 17 and have edges 29B from which the lower part of the axial cavity 9 extends. Starting from the edges 29B up to the bottom of the knob 5D of the spool 5 this lower part of the axial cavity 9 has a cross section smaller than the cross section of the axial cavity above the projections 21, where said axial cavity 9 must also house the spring 11. The surfaces 21A mutually converging toward each respective opening 17B extend from the respective surface or wall 29. In this way, optimal guiding of the cutting line is obtained when it is inserted through a channel 17. The head of the line that enters the axial cavity 9 from one of the channels 17 is directed toward the second opening 17B, or diametrically internal opening 17B, of the opposite channel 17 and enters easily therein due to the guiding action of the converging walls 21A and of the wall or surface 29 below.

At the edges 29B the axial cavity 9 has an elongated cross section, with a smaller dimension in the direction of the cutting line insertion channels 17 and a larger dimension in the direction orthogonal to the surfaces 21B. Above the edges 29B, the axial cavity 9 is delimited by the surfaces 21A 21B of the projections 21 for supporting the spring 11.

In the embodiment of FIGS. 11 to 17 the insert 15 has a small axial length and is completely housed in the seat 13A formed by the collar 13. Therefore, the axial cavity 9 of the spool is completely free and the line F can pass easily therethrough in radial direction, guided by the walls 21A, 21B of the projections 21. These latter ensure that the spring 11 remains above the openings 17B of the cutting line insertion channels 17, preventing interference between this latter and the spring 11.

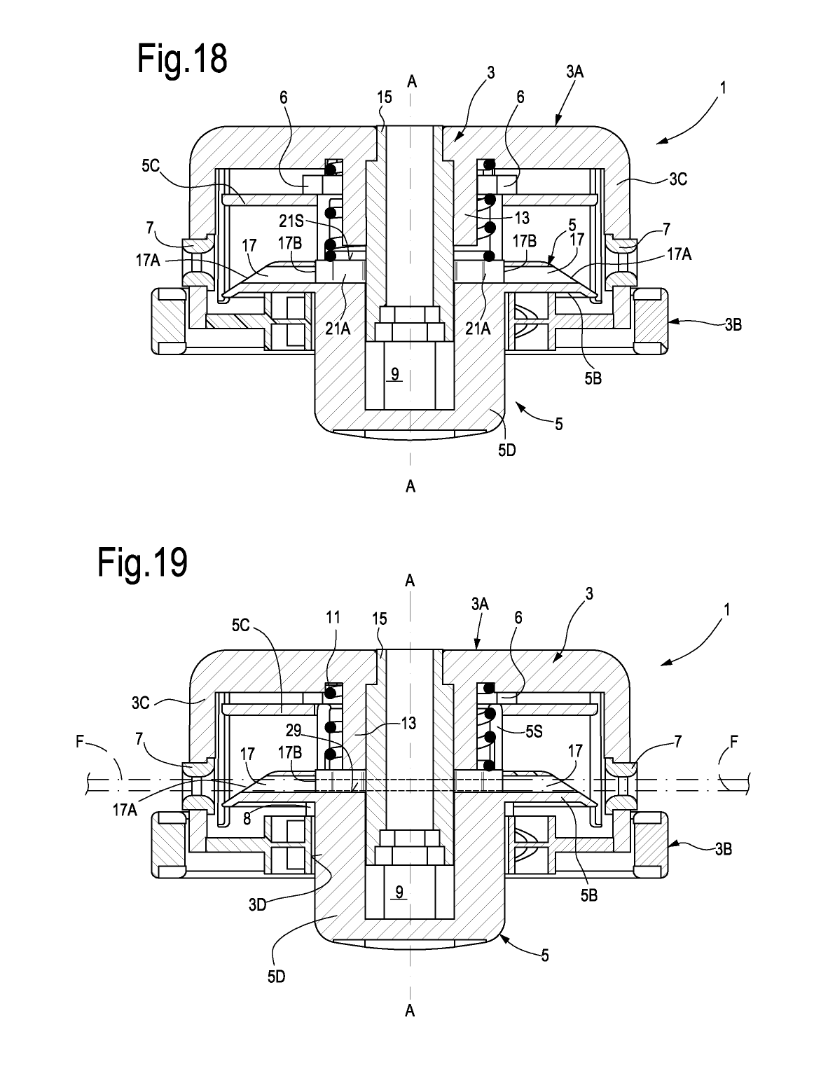

FIGS. 18 and 19 show, in sections similar to those of FIGS. 11 and 12, a grass-cutting head 1 substantially the same as the one described with reference to FIGS. 11 to 17, with the difference that the insert 15 for mechanical coupling of the grass-cutting head 1 to the motor shaft of a mower has a greater axial length and extends from the collar 13 in the axial cavity 9 of the spool 5 to beyond the edges 29B and the projections 21. In this case the insert 15 therefore also occupies part of the axial cavity 9 in the area thereof having a reduced cross section. When the cutting line F is inserted through the head, it always enters the axial cavity 9 of the spool 5 and passes around the insert 15, guided by the surfaces 21A, 21B, 21A forming in part the wall of the axial cavity 9.

The projections 21 for supporting of the spring 11 can be in direct contact with the spring, as shown in the accompanying drawings. Nonetheless, this is not strictly necessary. In fact, a washer or other separating elements can also be interposed between the supporting projections 21 and the spring 11.

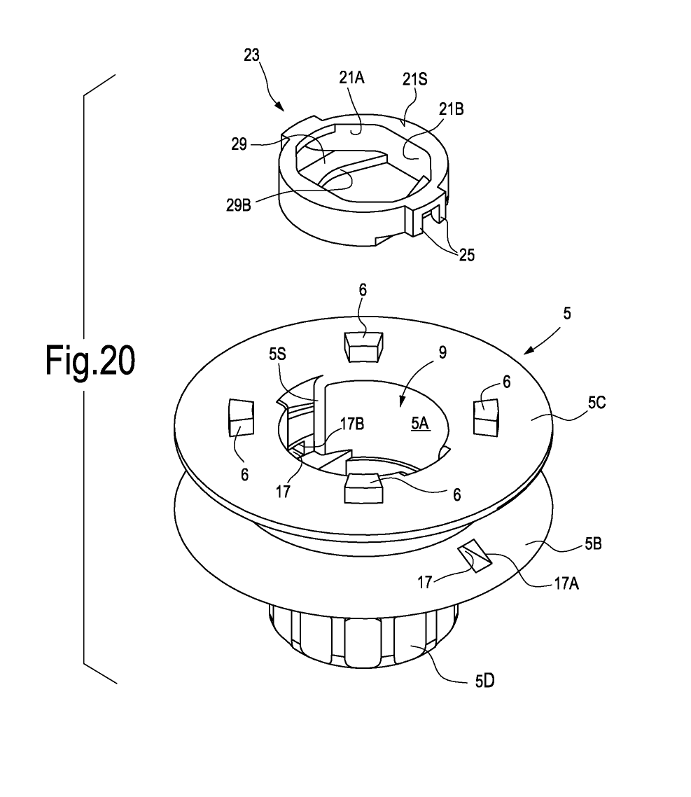

FIG. 20 shows an embodiment of the spool similar to the one illustrated in FIG. 8. The same reference numbers indicate the same or equivalent parts to those of FIG. 8. In the embodiment of FIG. 20 the appendages 25 of each pair of appendages are connected to each other by a bridge that forms a flat surface forming an extension of the supporting surface 21S. In this way the spring 11 has a continuous annular supporting surface.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions. In addition, the order or sequence of any process or method steps may be varied or re-sequenced according to alternative embodiments.

1. A grass-cutting head with cutting line, the grass-cutting head comprising:
an outer housing;
a spool housed in the outer housing, the spool comprising a central body with a rotation axis, about which a cutting line is wound, an axial cavity in the central body, into which an insert for mechanical coupling of the head to a motor shaft can be introduced, two opposite cutting line insertion channels, each of said two opposite cutting line insertion channels extending approximately radially from a respective first opening toward a respective second opening positioned in the axial cavity;
a compression spring arranged inside the housing and substantially coaxial to the spool, which elastically biases the spool with respect to the housing;
at least two bushings in approximately diametrically opposite positions in a lateral wall of the outer housing, said bushings being alignable with the first openings of the two opposite cutting line insertion channels, wherein in the axial cavity of the spool two opposite projections for supporting the spring are formed, forming pairs of lead-in and guide surfaces converging toward the respective second openings of the two opposite cutting line insertion channels.

2. The head as claimed in claim 1, wherein in front of the second openings of the two opposite cutting line insertion channels two respective surfaces are formed, which are substantially transverse with respect to the rotation axis of the spool, and wherefrom the respective converging lead-in surfaces formed by the projections for supporting the springextend.

3. The head as claimed in claim 1, wherein the lead-in surfaces are substantially symmetrical with respect to a plane containing the axis of the spool and passing through the two opposite cutting line insertion channels.

4. The head as claimed in claim 1, wherein the spool further comprises at least one flange extending around the axis of the spool, and wherein the two opposite cutting line insertion channels are at least partly formed in said flange.

5. The head as claimed in claim 4, wherein the first openings of said opposite cutting line insertion channels are located along a perimeter edge of the flange.

6. The head as claimed in claim 1, wherein the projections for supporting the spring are formed by a supporting member separate with respect to the spool, and inserted in the axial cavity of the central body of the spool.

7. The head as claimed in claim 2, wherein the projections for supporting the spring are formed by a supporting member separate with respect to the spool, and inserted in the axial cavity of the central body of the spool, wherein the surfaces substantially orthogonal to the rotation axis are formed by walls of the supporting member.

8. The head as claimed in claim 6, wherein the supporting member is substantially disk-shaped with a central aperture.

9. The head as claimed in claim 6, wherein the supporting member comprises pairs of approximately diametrically opposite appendages, which are aligned with the two opposite cutting line insertion channels, each pair of appendages being arranged in front of a respective one of said second openings of the two opposite cutting line insertion channels, and the lead-in and guide surfaces converging toward each of said second openings are joined to the respective pair of appendages.

10. The head as claimed in claim 6, wherein the axial cavity of the spool has a radial shoulder on which the supporting member is positioned.

11. The head as claimed in claim 6, wherein: the body of the spool has opposed longitudinal grooves substantially parallel to the rotation axis, aligned with the two opposite cutting line insertion channels; and wherein the supporting member comprises opposed appendages that are inserted into the longitudinal grooves.

12. The head as claimed in claim 1, wherein the axial cavity has an inner wall at least partly formed by the opposed lead-in and guide surfaces formed by the two opposite projections for supporting the spring.

13. The head as claimed in claim 1, wherein the axial cavity of the spool has an elongated transverse cross section, with a minor axis and a major axis, the minor axis being substantially parallel to the two opposite cutting line insertion channels.

14. The head as claimed in claim 1, wherein the two opposite projections for supporting the spring are produced integrally and in one piece with the body of the spool.

15. A grass-cutting head with cutting line comprising:
an outer housing;
a spool housed in the outer housing and provided with an axial cavity approximately parallel to a rotation axis of the spool;
a spring elastically biasing the spool with respect to the outer housing; and
two bushings approximately diametrically opposite in a lateral wall of the outer housing, the spool comprising two opposite cutting line insertion channels, each of the two opposite cutting line insertion channels being provided with a respective first diametrically external opening facing the lateral wall of the housing, and a second diametrically internal opening facing the axial cavity of the spool, wherein in the axial cavity of the spool two opposite projections for supporting the spring are arranged, forming pairs of lead-in and guide surfaces converging toward respective second openings of the two opposite cutting line channels insertion.

16. The grass-cutting head as claimed in claim 15, wherein a surface is arranged between the two converging lead-in surfaces positioned in front of the second opening of each cutting line insertion channel, said surface being transverse with respect to the rotation axis of the spool, from which the two converging guide surfaces extend.
